(19) United States
(12) Patent Application Publication
(10) Pub. No.: US 2024/0087762 A1
(43) Pub. Date: Mar. 14, 2024

(54) IN-SITU CREEP CAPSULE FOR A NUCLEAR REACTOR AND METHODS OF USE

(71) Applicant: Purdue Research Foundation, West Lafayette, IN (US)

(72) Inventors: Maria A. Okuniewski, West Lafayette, IN (US); Dulus Owen, New London, CT (US)

(21) Appl. No.: 18/465,510

(22) Filed: Sep. 12, 2023

Related U.S. Application Data
(60) Provisional application No. 63/405,586, filed on Sep. 12, 2022.

(51) Int. Cl. G21C 17/10; G01D 5/22; H01F 27/10

(52) U.S. Cl. CPC G21C 17/10; G01D 5/2291; H01F 27/10

(57) ABSTRACT

An in-situ creep capsule for a nuclear reactor, and methods of using. The capsule has a modular design which allows it to be used to test multiple different types and sizes of specimens and to be adapted for use in various different nuclear reactor configurations. The capsule may include an integrated heat exchanger to cool measuring instrumentation, which allows the capsule to be used for gathering data in-situ in next generation reactors with higher temperatures while the reactor is running.

### CROSS-REFERENCE TO RELATED APPLICATIONS

This application claims the benefit of U.S. Provisional Application No. 63/405,586 filed Sep. 12, 2022, the contents of which are incorporated herein by reference.

### STATEMENT REGARDING FEDERALLY SPONSORED RESEARCH

This invention was made with government support under DE-AC07-05ID14517 awarded by United States Department of Energy. The government has certain rights in the invention.

### BACKGROUND OF THE INVENTION

The invention generally relates to an in-situ creep capsule for a nuclear reactor and methods of measuring creep in a nuclear reactor using the in-situ creep capsule.

Nuclear reactors operate under extreme environmental conditions, such as neutron bombardment, elevated temperatures, and high pressures. Over time, the harsh environmental conditions affect the material properties of structural materials and fuels. Studying the mechanical properties of structural materials and advanced fuels is a common practice that is required to validate the material performance for deployment within next-generation reactors. Next-generation reactors, such as Generation-IV reactors, will operate in more extreme environments than the current fleet of power reactors, with temperatures reaching potentially over 1000° C. and the use of corrosive coolants, such as lead, lead-bismuth, and liquid sodium. Studying in-situ mechanical properties, such as irradiation creep, is challenging, particularly in next-generation reactor conditions.

Creep is a time-dependent plastic deformation of a material under constant stress, heat, and/or radiation. Thermal and irradiation creep are two phenomena that occur during the operating lifetime of a reactor. Thermal creep is predominant at elevated temperatures or above half the melting temperature of a material (0.5>Tm). When a material is exposed to radiation, the crystal structure of the material can be damaged, causing defects that induce the mechanisms of irradiation creep. An in-situ study of irradiation creep and other material properties in candidate structural materials for use in a nuclear reactor, such as HT-9 steel and Haynes 230, or fuels for use in a nuclear reactor, such as uranium dioxide (UO₂) and mixed oxides, is required to validate them for use in Generation-IV reactors. Irradiation creep has historically been studied using a variety of methods, including both in-reactor testing with real-time monitoring (in-situ) and post-irradiation experiments or out-of-pile testing (ex-situ). In-situ creep testing has demonstrated a more representative creep profile than ex-situ testing. During in-situ testing, a material is irradiated, and property changes of the material are monitored in real-time using instrumented capsules.

In-situ creep capsules (ICCs) are instrumented rigs used for in-situ creep testing inside a nuclear reactor core, typically of irradiation creep. ICCs must collect data in real-time while experiencing harsh in-reactor conditions. Many ICCs utilize instruments for monitoring irradiation creep in the candidate materials while in-reactor and in real-time. Many previous and existing in-situ creep capsules have implemented a variety of designs to measure irradiation creep. Conventional ICCs typically include three major assemblies, referred to herein as the strain measuring, loading mechanism, and specimen mount assemblies. Various conventional ICCs have included a linear variable differential transducer (LVDT) for measuring strains, a bellows as a loading mechanism to induce stress in a test specimen, thermocouples, and a self-powered neutron detector (SPND) for measuring neutron bombardment.

There are many different methods of measuring in-situ creep, and different measurement methods typically require various different unique designs of an ICC. In addition, the geometry of a specimen significantly influences how strain is measured and how the load can be applied. Further, the array of specimens that can be tested is typically limited to relatively small “sub-sized” geometries since the available test space within a reactor core is limited. Two variables primarily determine the design of an ICC: the specimen type and the strain measuring instrument. The specimen type determines the loading mechanism needed to perform an in-situ creep test. Bellows have become the principle loading mechanism due to their ability to apply a variable load and smaller size, allowing them to accommodate ICC diameter limitations. LVDT strain measuring instruments are typically used because they are compact and can fit within ICC diameter limitations.

Previously known ICCs have located both the loading mechanism and the strain measurement instrument adjacent to the specimen within the reactor core to improve the reliability of creep measurements. However, previous and existing ICCs have had issues such as buckling when applying the strain measuring instrument and loading mechanism onto the specimen.

In addition, a new “versatile test reactor” (VTR) being developed for testing various nuclear reactor designs is being designed and equipped with cartridge loop systems capable of simulating lead- and gas-cooled fast reactors, molten salt reactors, and sodium-cooled reactors. As a result, an ICC for use in this new versatile test reactor would preferably be designed to test advanced structural materials and fuels in various loop systems. The ICC preferably would also be rated for harsh environmental conditions, including corrosive fluids and elevated temperatures. The ICC preferably also would be versatile in its testing capabilities, which facilitates private and public collaboration and improves in-reactor testing. However, conventional known ICCs are typically designed for a single or highly limited set of test parameters, which reduces their versatility for use in a larger variety of testing situations, and thereby can increase testing costs and/or complications for testing a wide range of parameters and environments.

In view of the above, it would be desirable to have an in-situ creep capsule that is capable of improving the accuracy of measuring irradiation creep in real time, allowing for testing of a wider range of specimen geometries, and/or allowing for testing in a wider range of harsh environmental conditions likely to be experienced in new nuclear reactor designs.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, in-situ creep capsules for a nuclear reactor and methods of measuring creep in a test specimen in a nuclear reactor using in-situ creep capsules.

According to a nonlimiting aspect of the invention, an in-situ creep capsule for a nuclear reactor includes a specimen mount assembly for securing a test specimen between a first grip assembly and a second grip assembly within a test volume, a loading assembly having a loading mechanism for placing a load on the test specimen secured between the first and second grip assemblies, and a transducer assembly having instruments for measuring strain in the test specimen secured between the first and second grip assemblies when subjected a load from the loading assembly. At least one of the first and second grip assemblies includes a wedge and a cap, wherein the wedge wedges a head portion of a testing specimen within the cap to secure the testing specimen.

According to another nonlimiting aspect of the invention, an in-situ creep capsule for a nuclear reactor includes a specimen mount assembly for securing a test specimen within a test volume, a loading assembly having a loading mechanism for placing a load on the test specimen secured between the first and second grip assemblies, and a transducer assembly having an instrument for measuring strain in the test specimen secured in the specimen mount assembly when subjected a load from the loading assembly. The transducer assembly includes an integrated heat exchanger for cooling the instrument.

According to yet another nonlimiting aspect of the invention, an in-situ creep capsule for a nuclear reactor includes a specimen mount assembly having one or more grip assemblies for securing a test specimen within a test volume, a loading assembly having a loading mechanism for placing a load on the test specimen secured between the first and second grip assemblies, and a transducer assembly having instruments for measuring strain in the test specimen secured in the specimen mount assembly when subjected a load from the loading assembly. The loading assembly comprises a brace rod, and the specimen mount assembly comprises a brace mount. The brace rod slides into the brace mount to couple the specimen mount assembly to the loading assembly.

According to still another nonlimiting aspect of the invention, a method of measuring creep in a test specimen in a nuclear reactor includes loading the test specimen into any of the above-mentioned in-situ creep capsules and securing the head portion of the test specimen in the cap with the wedge, placing the in-situ creep capsule loaded with the test specimen in a reactor core of a nuclear reactor while the nuclear reactor is running for a period of time, and measuring creep of the test specimen during the time period using the in-situ creep capsule.

According to still another nonlimiting aspect of the invention, a method of measuring creep in a test specimen in a nuclear reactor includes loading the test specimen in one of the above described in-situ creep capsules, placing the in-situ creep capsule loaded with the test specimen in a reactor core of a nuclear reactor while the nuclear reactor is running for a period of time, measuring creep of the test specimen during the time period using the in-situ creep capsule, and cooling the instrument for measuring strain using the integrated heat exchanger.

Technical aspects of in-situ creep capsules and methods having features as described above preferably include the capability of overcoming or reducing one or more of the previously mentioned drawbacks of previously known ICCs, provide a more versatile ICC for use in next-generation nuclear reactors, and/or provide one or more of the advantages mentioned elsewhere herein.

These and other aspects, arrangements, features, and/or technical effects will become apparent upon detailed inspection of the figures and the following description.

### BRIEF DESCRIPTION OF THE DRAWINGS

FIG. 1 is a perspective view of an in-situ creep capsule according to certain non-limiting aspects of the invention with some outer surfaces shown as partially translucent to aid in the visualization of internal features.

FIG. 2 is a front side elevation view of the in-situ creep capsule of FIG. 1 with a quarter cutaway so that the right half shows an axial cross-sectional view.

FIG. 3 is a top end view of the in-situ creep capsule of FIG. 1 with the quarter cutaway illustrated in FIG. 2.

FIG. 4A is an enlarged axial cross-sectional view of a transducer assembly of the in-situ creep capsule of FIG. 1.

FIG. 4B is a schematic cross-sectional representation of portions of the transducer assembly of FIG. 4A showing flow of coolant through an integrated heat exchanger of the transducer assembly.

FIG. 5 is a perspective exploded view of a transducer mount, a transducer shell, and leads mount of the transducer assembly of FIG. 4A.

FIG. 6 is an enlarged view in partial axial cross-section of a loading assembly of the in-situ creep capsule of FIG. 1.

FIG. 7 is an enlarged view in partial axial cross-section of a specimen mount assembly of the in-situ creep capsule of FIG. 1.

FIG. 8 is a perspective view of a brace mount and yoke of the specimen mount assembly of FIG. 7 with some exterior surfaces shown as partially translucent to aid I the visualization of internal features.

FIG. 9 is a perspective view of the in-situ creep capsule of FIG. 1 in a partially disassembled configuration and illustrating a process of joining of the loading assembly to the specimen mount assembly.

FIG. 10 is an enlarged cross-sectional view of an upper grip assembly in the specimen mount assembly of FIG. 7, the lower grip assembly being substantially similar and optionally with minor dimensional variations.

FIG. 11 is a three-quarters partial cutaway view of the upper grip assembly of FIG. 10 with a cylindrical specimen and depicting a frustoconical wedge in a cap of the upper grip assembly.

FIG. 12 is a three-quarters partial cutaway view of an alternative upper grip assembly with a flat plate specimen and depicting a shoulder wedge in a cap of the upper grip assembly.

FIG. 13 is a partially translucent perspective view of the cylindrical specimen of FIG. 10 and the cap and frustoconical wedges designed to be placed over the specimen and wedged between the cap and specimen.

FIG. 14 is a partially translucent perspective view of the flat plate specimen of FIG. 12 and the cap with shoulder wedges designed to be placed over the specimen and wedged between the cap and specimen.

FIG. 15 is a cross-sectional view of a cap of the grip assemblies of FIGS. 10 through 14.

FIG. 16 is a perspective view of a grip mount of the grip assemblies of FIGS. 10 through 14.

FIG. 17 is a side view of seven different configurations of grip assemblies of the types depicted of FIGS. 10 through 14 and shown operatively mounted with seven different respective test specimens, each different test specimen having different size and shape characteristics than other test specimens.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of the embodiment(s) to which the drawings relate. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the in-situ creep capsule during its use and/or as represented in the drawings. All such relative terms are useful to describe the illustrated embodiment(s) but should not be otherwise interpreted as limiting the scope of the invention.

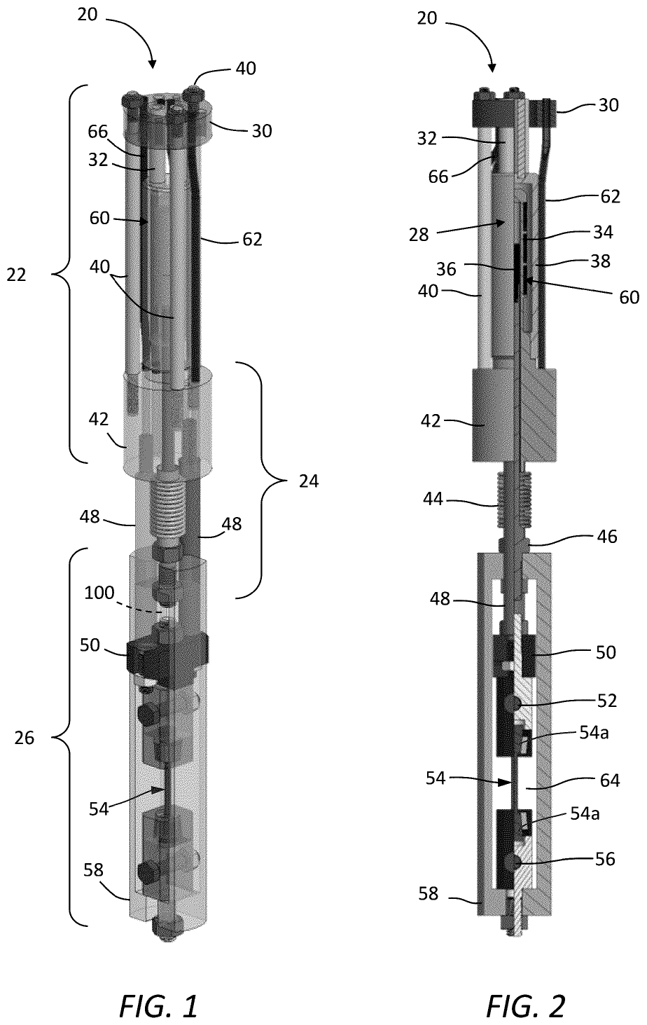

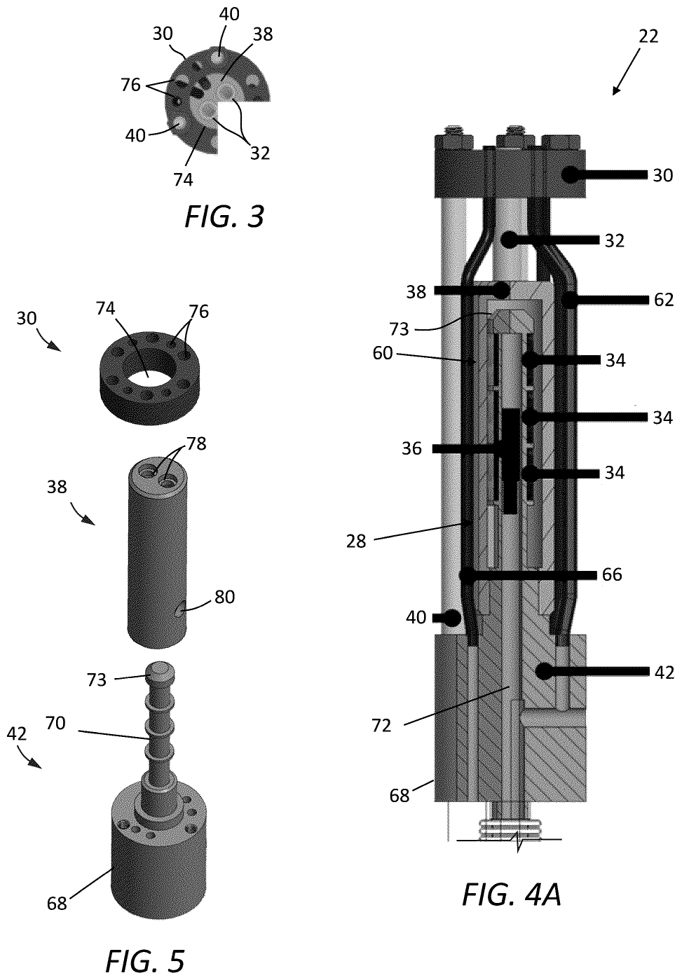

Turning now to the nonlimiting embodiments represented in the drawings, FIGS. 1-3 depict an in-situ creep capsule 20 (also referred to as an “ICC” or simply the “capsule”) according to a nonlimiting embodiment of the invention for measuring creep of an exemplary test specimen 54 while the capsule 20 is disposed in a core of a nuclear reactor while the reactor is running. Although the following description refers primarily to specimens of types such as represented in FIGS. 1 and 2, a variety of specimens having different geometries can be tested within the capsule 20. The capsule 20 is represented as having a modular design intended to allow for different specimens 54 to fit within the capsule 20. Some nonlimiting examples of different specimens 54 are discussed below and represented in the drawings.

The capsule 20 has three primary assemblies each preferably constituting a module (modular unit) of the capsule 20. These assemblies include a strain measuring instrument (transducer) assembly 22 carrying strain measuring instrumentation (e.g., a transducer), a loading assembly 24 carrying a loading mechanism, and a specimen mount assembly 26 for securing a test specimen (e.g., the specimen 54) that will or is undergoing strain testing within the capsule 20. In the non-limiting embodiment of FIGS. 1 and 2, the strain measuring assembly 22 includes a linear variable differential transducer (LVDT) 60 as a strain measuring instrument (transducer) and therefore will also be referred to herein as the transducer assembly 22, the loading assembly 24 includes a bellows 44 as a loading mechanism, and the specimen mount assembly 26 includes first and second (upper and lower) grip assemblies 52 and 56 that secure opposite ends of the test specimen 54 and therefore will also be referred to herein as the specimen mount assembly 26. Although the assemblies 22 and 24 are generally referred to hereinafter as the transducer assembly 22 and the loading assembly 24 for ease of reference to the embodiment depicted in the drawings, one or more other types of strain measuring instrument assemblies, loading assemblies, and specimen mounting assemblies could be used in other embodiments in various combinations. Each assembly 22, 24, and 26 is preferably a modular unit that allows for simple construction and disassembly of the capsule 20. The modular design of the capsule 20 also reduces the possibility of damaging the instruments and specimens before and after an irradiation experiment. The modular design of the capsule 20 preferably provides additional benefits. For example, the modularity of the specimen mount assembly 26 preferably provides the capsule 20 with versatility, since specimens having a variety of different sizes and geometries can be tested. This functionality allows the capsule 20 to be used for testing a wide range of material candidates for next-generation reactors and for testing multiple different specimen geometries.

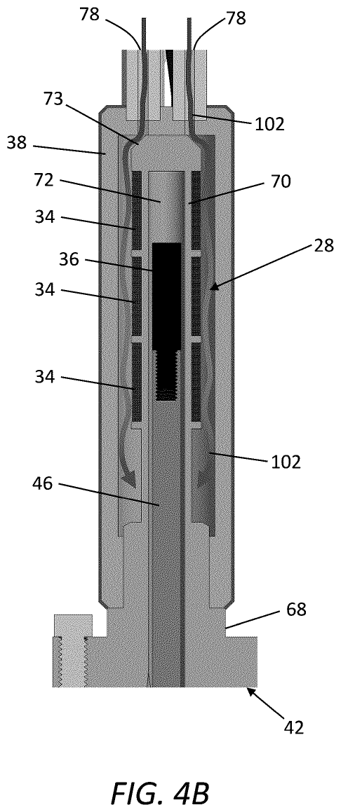

As best seen in FIGS. 4A and 5, the transducer assembly 22 housing the LVDT 60 is located near the specimen 54 and above the bellows (loading mechanism) 44 of the loading (bellows) assembly 24. By having the LVDT 60 positioned near the specimen 54, the LVDT 60 is located in the reactor core during in-situ operation and will experience temperatures up to 1000° C. The LVDT 60 can operate at extreme temperatures using an integrated heat exchanger 28 that is integrated into the transducer assembly 22, as described hereinafter, for regulating the internal temperature of the LVDT 60. The bellows 44 housed in the loading assembly 24 is adapted to apply a downward force onto a transducer probe 46 and yoke 58 via the introduction of internal pressure within the bellows 44. A gas pressurization tube 62 passes through a transducer mount 42 and into the bellows 44, allowing for variable pressure to be introduced as the internal pressure within the bellows 44. Buckling or bending of the specimen 54 is reduced by locating the bellows 44 near the specimen 54, which solves a historical issue of long links buckling within previous ICCs. A test volume 64 is defined by the specimen mount assembly 26 and sized and configured to receive the specimen 54, which as previously noted may have a variety of different geometries. The modular design of the specimen mount assembly 26 facilitates the testing of specimens 54 with different geometries, enabling the unique ability to test various specimen geometries not capable in previous ICCs. Each of these assemblies 22, 24, and 26 is discussed in more detail hereinafter.

The components of the transducer assembly 22 are disposed in an upper region of the capsule 20 for assisting in measuring strain and applying a load onto the test specimen 54. The transducer assembly 22 includes the LVDT (strain measuring instrument) 60, instrument leads, and structural parts such as the transducer mount 42 on which the LVDT 60 is mounted, a leads mount 30, and connecting rods 40. The mounts 30 and 42 and connecting rods 40 rigidly hold the transducer assembly 22 static during an irradiation experiment and assist in creating a reaction force on the test specimen 54. As best seen in FIGS. 4 and 5, the components of the transducer assembly 22 further include the integrating heat exchanger 28 for the LVDT 60 and a transducer shell 38 enclosing the LVDT 60. The LVDT 60 is represented as including primary and secondary LVDT coils 34 surrounding a transducer core 36 (also called an “LVDT core” herein), and the transducer assembly 22 includes transducer lead tubes 32 associated with the LVDT 60, and optionally an instrument tube 66 for other instrument leads. The components of the integrating heat exchanger 28 may be formed by additive manufacturing, for example, but other suitable methods, such as casting or machining, may also be used.

The transducer mount 42 is utilized for mounting the LVDT 60, securing the pressurization tube 62, instrument tube 66, and leads tube 32, and grounding the loading and specimen mount assemblies 24 and 26. The transducer mount 22 carries and/or houses the LVDT internals, such as the primary and secondary LVDT coils 34 and the transducer core 36. The transducer mount 42 has a base section 68 and a hollow rod section 70 extending upwardly from a central portion of an upper side of the base section 68. A blind bore 72 extends from a lower side of the base section 68 into the hollow rod section 70. The LVDT core 36 is disposed inside the blind bore 72 in the hollow rod section 70, and the LVDT coils 34 are wrapped around the outside of the hollow rod section 70 along the length of the LVDT coil 36. Blind holes and through-holes are drilled into the base portion 68 of the transducer mount 42, allowing the tubes 62 and 66 to penetrate or pass through. The tubes 66 carry instrument and/or instrument leads for thermocouples and self-powered neutron detectors (SPNDs) and/or other equipment as needed. Since the transducer assembly 22 is static, a reaction force is placed onto the specimen 54 when the bellows are pressurized 44, creating tensile stress.

The transducer shell 38 protects the LVDT coils 34 from harsh environmental conditions. The transducer shell 38 mounts onto the base portion 68 of the transducer mount 42, for example with electron beam welding or other suitable connector, and extends along the length of and surrounds the hollow rod section 70 of the transducer mount 42, thereby enclosing and preferably sealing the LVDT coils 34 therein. The transducer shell 38 has a generally cylindrical shape with a generally cylindrical sidewall and an upper end wall defining an interior cavity and open lower end.

The connecting rods 40 connect the transducer mount 42 to the leads mount 30 and in a preferred arrangement, ultimately, to the top of the reactor core. Threads are disposed on both ends of the connecting rods 40 so that one end of each connecting rod 40 threads into the upper side of the base portion 68 of the transducer mount 42, and the other end of each rod 40 fastens to the leads mount 30, for example with nuts, thereby rigidly connecting the transducer mount 42 to the leads mount 30. In some nonlimiting configurations, stacking combinations of the connecting rods 40 and the lead mounts 30 that traverse outside the reactor core, preferably with each stacking combination oriented at 60° circumferential spacing around the hollow rod section 70.

The leads mount 30 guides and supports instrument leads through the capsule 20. The leads mount 30 has a generally ring-shaped body forming a middle hole (bore) 74 and with several peripheral through-holes (bores) 76 extending through the ring-shaped body. The transducer lead tubes 32, which in this example are in the form of short tube sections extending upwardly from inlets 78 of the transducer shell 38, pass through the middle hole 74 and the gas pressurization tube 62 and threaded ends of the connecting rods 40 pass through selected ones of the peripheral through-holes 76. The layout of the peripheral through-holes 76 in the leads mount 30 allows the transducer lead tubes 32 and gas pressurization tube 62 to be evenly spaced apart from each other around the ring-shaped body. Otherwise, the transducer lead tubes 32 and tubes 62 and/or 66 could collide, not allowing the various instruments desired to fit within the capsule 20.

To enable the capsule 20 to operate at elevated temperatures, the LVDT 60 is provided with the aforementioned integrated heat exchanger 28 to regulate the internal temperature below the Curie temperature of the LVDT coils 34. The heat exchanger 28 is formed by the combination of the transducer mount 42 and the transducer shell 38. The inlets 78 of the transducer shell 38 pass through the upper end cap of the shell 38 and the outlets 80 of the transducer shell 38 pass through the lower end of the shell 38 formed by two through-holes through the cylindrical sidewall of the shell 38 that are rotated 90° with respect to the inlets 78. The lead wires to the LVDT coils 34 extend through the transducer lead tubes 32 that carry the coolant fluid, keeping the wires at a suitable temperature. A typical maximum operating temperature for the secondary and primary LVDT coils 34 is about 600° C. As a result, it is preferable for the heat exchanger 28 to maintain the temperature of the LVDT coils 34 at temperatures not significantly greater than 600° C., even when the ambient temperature is far greater, e.g., 900° C., 1000° C., or more. As illustrated schematically in FIG. 4B, this is accomplished by having coolant pass along a coolant flow circuit 102 through the transducer shell 38 between the interior wall of the shell 38 and the outer surface of the hollow rod section 70 and LVDT coils 34. The coolant flow circuit 102 enters the shell 38 from its upper end and exits the shell 38 from its lower end. In the example shown in the drawings, the coolant flow circuit 102 allows coolant to enter the shell 38 through the inlets 78, flow across the LVDT coils 34 disposed between the inlets 78 and outlets 80, and then exit through the outlets 80 (visible in FIG. 5). Any coolant, such as water, oil, or cooled gases, may be used that is suitable for use in a nuclear reactor. Computational analyses showed that this design can maintain the LVDT coils 34 at a suitable maximum operating temperature of about 600° C. when subjected to reactor core temperatures of up to 900° C.

The transducer mount 42 may also assist with the heat exchange process of the integrated heat exchanger 28. For example, a chamfered peripheral edge 73 located on an upper (distal) end plate of the hollow rod section 70 of the transducer mount 42 helps direct the flow of coolant around the LVDT coils 34 for enhanced convection. Also assisting in the heat exchange process are the locations of the coil 34. The transducer mount 42 positions the LVDT coils 34 in the upper region of the transducer shell 38 so that they are positioned along the coolant flow circuit 102 between the inlets 78 and the outlets 80, thereby promoting adequate flow of the coolant across the entire length of the LVDT coils 34 to promote enhanced convection over all of the LVDT coils 34. The transducer mount 42 also helps with positioning instrument leads and applying stress to the specimen 54, as discussed hereinafter.

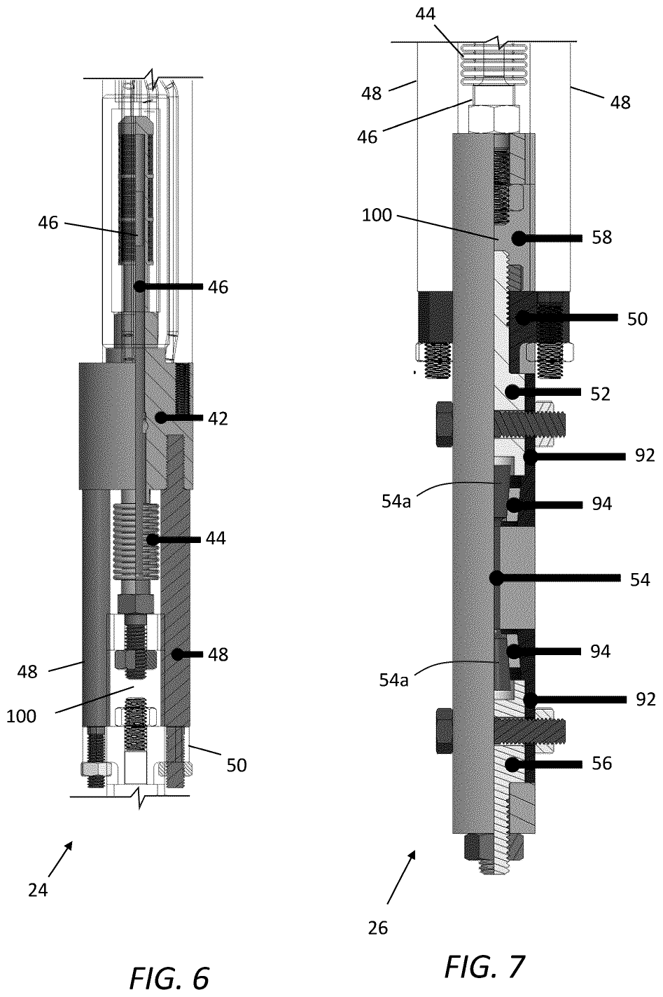

The loading assembly 24 is located generally in the middle of the capsule 20 between the transducer assembly 22 and the specimen mount assembly 26. The loading assembly 24 houses the loading mechanism (in this example, the bellows 44). As best seen in FIG. 6, the loading assembly 24 further includes the transducer probe 46, the transducer mount 42, and two brace rods 48. The transducer probe 46 is used to measure the strain of the specimen 54. An upper end of the bellows 44 is connected to a blind bore 72 of the transducer mount 42. A lower end of the bellows 44 is coupled to a coupling end of the transducer probe 46 such that a rod portion of the transducer probe 46 extends upwardly through the bellows 44 and into the blind bore 72 of the transducer mount 42 to the LVDT core 36. Though a variety of bellows could potentially be used, a particularly suitable bellows 44 is manufactured by Mini-Flex (stock number I718-320-110-790). The brace rods 48 rigidly connect a brace mount 50 to the transducer mount 42. The bellows 44 is connected to the transducer probe 46 and a lower side of the base portion 68 of the transducer mount 42, preferably by electron beam welding, to create a leak-tight loading assembly 24 so that a variable load can be applied to the specimen 54 by internally pressurizing the bellows 44 (as well as unload the specimen 54 by depressurizing the bellows 44). A gas used to pressurize the bellows is provided via the gas pressurization tube 62 and passes through the transducer mount 42 via the blind bore 72 into the bellows 44.

Static (fixed) parts of the loading assembly 24, including the transducer mount 42 and brace rods 48 help create tensile stress on the specimen 54 by creating reaction forces. When the bellows 44 is internally pressurized via gas passing through the gas pressurization tube 62 and transducer mount 42, the transducer probe 46 moves in an axial direction of the capsule 20. Because the transducer mount 42 is a static part, the bellows 44 can only move the transducer probe 46 and yoke 58 in the downward direction. The orientation of the static parts and yoke 58 helps with applying a tensile stress on the specimen 54 by creating a reaction force caused by the bellows 44. For the specimen 54 to experience tensile stress, reaction forces are needed. The static parts of this assembly 24, namely, the transducer mount 42 and brace rods 48, create the needed reaction forces. For example, the opposite threaded ends of the brace rods 48 are rigidly connected to the transducer mount 42 and the brace mount 50, which is in turn are rigidly connected to the upper grip assembly 52. Thus, the brace mount 50 rigidly connects the upper grip assembly 52 to the static transducer mount 42 via the brace rods 48, thereby creating the desired reaction force when the bellows 44 is pressurized.

The specimen mount assembly 26 is positioned at a lower or bottom end of the in-situ creep capsule 20 and serves to house and secure the specimen 54. As seen best in FIG. 7, the specimen mount assembly 26 includes the upper and lower grip assemblies 52 and 56, the brace mount 50, and the yoke 58. Although the specimen mount assembly 26 is shown and described with the specimen 54 mounted for ease of understanding the functionality of the capsule 20, the specimen 54 is not necessarily part of the capsule 20 per se, but rather is a separate item that is removably mounted in the specimen mount assembly 26 and therefore is replaceable. By changing the design of the lower and upper grip assemblies 52 and 56 relative to previously known ICCs, as described in greater detail hereinafter, specimens having various different geometries can be successfully tested using the same specimen mount assembly 26 with only minor adjustments to various components thereof in a way that is believed to not heretofore have been possible.

The brace mount 50 is rigidly attached to lower ends of the brace rods 48, for example, with a threaded connection and/or fasteners. The upper grip assembly 52 is rigidly secured under the brace mount 50 with a threaded bolt portion of a grip mount 90 (best seen in FIG. 16) that fastens to the brace mount 50. The static parts of the specimen mount assembly 26 are the brace mount 50 and the grip mount 90 of the upper grip assembly 52 because the brace mount 50 and the brace rods 48 are substantially rigidly fastened together in the specimen mount assembly 26. These static parts create the needed reaction force to apply a tensile load onto the specimen 54. The upper grip assembly 52 can be releasably secured to an upper end of the test specimen 54 as described in more detail hereinafter.

The yoke 58 transfers a load produced from the bellows 44 to the test specimen 54. To accomplish this, an upper end wall of the yoke 58 is coupled to a lower end of the transducer probe 46. The yoke 58 has two rails that extend down from an upper end wall on opposite sides of the test volume 64 to a lower end wall. The grip mount 90 of the lower grip assembly 56 is coupled to the lower end wall with a threaded bolt section and extends upwardly into the test volume 64, and the lower grip assembly 56 can be releasably secured to a lower end of the test specimen 54. Thus, in contrast to the static parts, the dynamic parts include the yoke 58, the lower grip assembly 56, and the specimen 54, which are free to move in the axial direction of the capsule 20 relative to the brace mount 50 and other static parts. The corresponding parts fastened to the brace mount 50 and yoke 58, e.g., the brace rods 48 and lower grip assembly 56, can slide in and out of the brace mount 50 and yoke 58. In this way, the static parts maintain the upper end of the test specimen 54 in a fixed position (relative to the transducer assembly 22), and the dynamic parts move the lower end of the test specimen 54 axially downwardly in response to an increased pressure in the bellows 44 to place a strain on the specimen 54.

The modular design of the capsule 20 is an aspect of its unique functionality. For example, the modular design of the brace mount 50, yoke 58, and upper and lower grip assemblies 52 and 56 allow for simple assembling and disassembling. With a set dimensional region between the brace mount 50 and the lower end of the yoke 58, grips and specimens of various designs can fit within the test volume 64. In the nonlimiting example shown in the drawings (e.g., FIG. 2), the test volume 64 available for specimens to fit within is delimited by a region between the upper and lower grip assemblies 52 and 56 and has a set length and width, as nonlimiting examples, 80 mm and 16 mm, respectively. Other dimensions may be used depending on the intended use parameters.

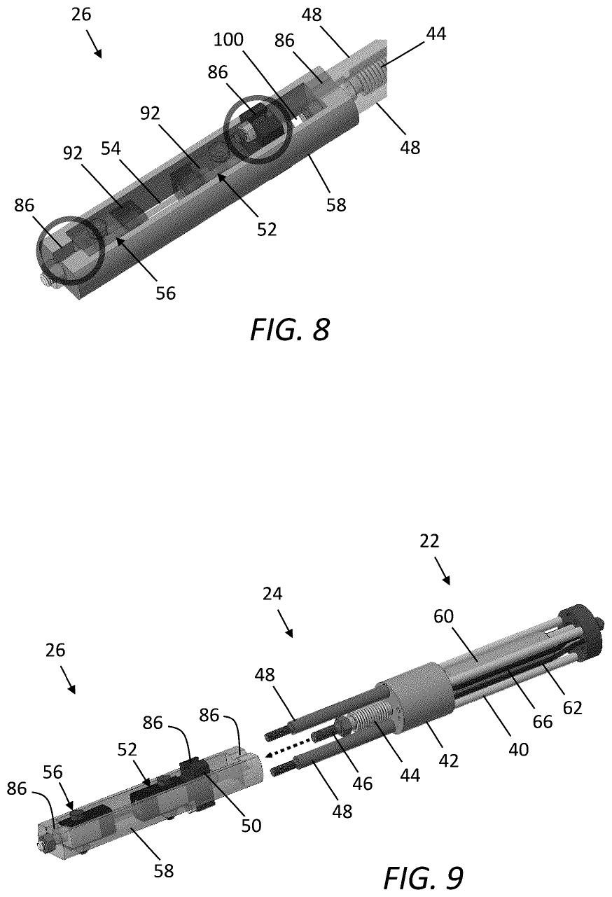

As best seen in FIG. 8, slots 86 within each of the brace mount 50 and yoke 58 facilitate the assembly and disassembly process of the specimen mount assembly 26. The slots 86 allow the lower grip assembly 56 and brace rods 48 to slide easily in and out. For example, should threads in the assembly 26 experience galling caused by elevated operating temperatures, the specimen 54 can be removed from the capsule 20 safely. In that case, the brace rods 48 can be cut from the transducer mount 42, and the grip assemblies 52 and 56 and specimen 54 can be removed from the yoke 58 while preserving the specimen 54.

The modular design of the capsule 20 promotes a convenient assembly and disassembly process for joining the specimen mount assembly 26 with the loading assembly 24. As illustrated in FIG. 9, the bellows 44 slides axially into and out of the yoke 58 and brace mount 50 for simple assembly because the brace rods 48 have a fixed distance between each other when threaded into the transducer mount 42. Thus, for example, to assemble the capsule 20, the loading assembly 24 slides into the brace mount 50 by sliding the brace rods 48 axially into the slots 86 on opposite lateral sides of the brace mount 50. Once assembled, the brace rods 48 are secured to the brace mount 50, for example with threaded fasteners (e.g., nuts). In FIG. 9, the transducer assembly 22 is already assembled and mounted to the loading assembly 24, and the combined assemblies 22 and 24 are aligned for assembly to the specimen mount assembly 26. However, this assembly process can be performed either with or without the transducer assembly 22 already being assembled and mounted to the loading assembly 24. To assemble the loading assembly 24, the upper end of the bellows 44 is secured to the blind bore 72 of the transducer mount 42 and a fluid-tight seal is formed therebetween, for example, by welding or with a threaded connection and/or seals. The transducer probe 46 is inserted into and through the bellows 44 and the base of the probe 46 is sealed to the lower end of the bellows 44 to form a sealed chamber in the probe 46. Then, the upper ends of the brace rods 48 are threaded into corresponding threaded bores in the lower side of the transducer mount 42. To assemble the transducer assembly 22, the LVDT coils 34 and LVDT core 36 are mounted in their respective positions along the hollow rod section 70 of the transducer mount 42. Then, the transducer shell 38 and any additional instrumentation and leads that are to be positioned in the LVDT 60 are mounted onto the transducer mount 42 enclosing the hollow rod section 70, and the transducer shell 38 is secured to the transducer mount 42, for example, by welds, threaded connections, or other sealing connections. The tubes 62 and 66 are coupled to their respective bores in the transducer mount 42, and the lower ends of the connecting rods 40 are secured to the upper side of the base section 68 of the transducer mount 42, for example by a threaded connection between the threaded ends of the rods 40 and threaded bores in the transducer mount 42. The leads mount 30 is mounted to the upper end of the connecting rods 40, for example, by sliding the upper ends of the rods through respective ones of the peripheral through-holes 76 in the leads mount, with the transducer leads tubes 32 extending into and/or through the central opening 74. The leads mount 30 is the secured to the upper ends of the connecting rods 40, for example with threaded fasteners (e.g., nuts) on the ends of the connecting rods 40, and the upper ends of any tubes 62 and 66 are secured to respective ones of the peripheral through-holes 76. The order of assembly may differ depending on the ease and needs of the situation. Due to the modular nature of this assembly and the use of removable fasteners, such as threaded connectors, disassembly can be accomplished by simply reversing most of the assembly steps in any desired order.

The grip assemblies 52 and 56 have a modular design that allows the specimen mount assembly 26 to be easily modified and configured to grip and secure a wide variety of types and sizes of test specimens 54. This allows the specimen mount assembly 26 to be easily adapted to mount and conduct strain (and possibly other) tests on test specimens 54 of many different sizes and shapes. In FIG. 17, for example, the capsule 20 is mounted with seven different test specimens 54, with modular components of the specimen mount assembly 26 arranged in corresponding different configurations to be able to secure each test specimen 54 within its respective test volume 64. In FIG. 17, the capsule 20 is configured and mounted with specimens 54 of two different configurations, namely, cylindrical and flat plates. Furthermore, FIG. 17 depicts three different sized cylindrical specimens 54 on the lefthand end of the series of assemblies 26, and four different sized flat plate specimens 54 on the righthand end of the series. In embodiments in which the test volume 64 has a length of 80 mm and a width of 16 mm, there are a variety of grip assemblies 52 and 56 that can be designed to be compatible with the test volume 54, and the capsule 20 is not limited by the cylindrical and flat plate specimens 54 of FIG. 17, but rather can be configured to mount many different types and sizes of test specimens that fit within the test volume 64. For example, different specimens 54, as nonlimiting examples, SS-1, SS-2, SS-3, SS-J3, ASTM E8/E8M, and ASTM-type specimens, and associated grip assemblies 52 and 56 are capable of fitting within a test volume 64 having a length and width of 80 mm and 16 mm, respectively. Given that creep can be difficult to observe in certain types of materials, the ability to modify and adapt the design of a specimen 54 can be advantageous. For example, the longer gauge length of the specimen 54 third from the left in FIG. 17 is designed to increase the observation of creep strain. A variety of other specimens can be adapted to fit within the test volume 64 of the capsule 20 to meet the requirements of a wide variety of different experiments.

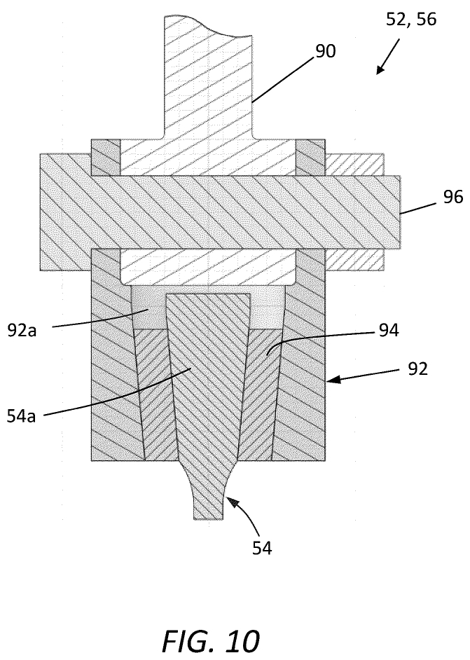

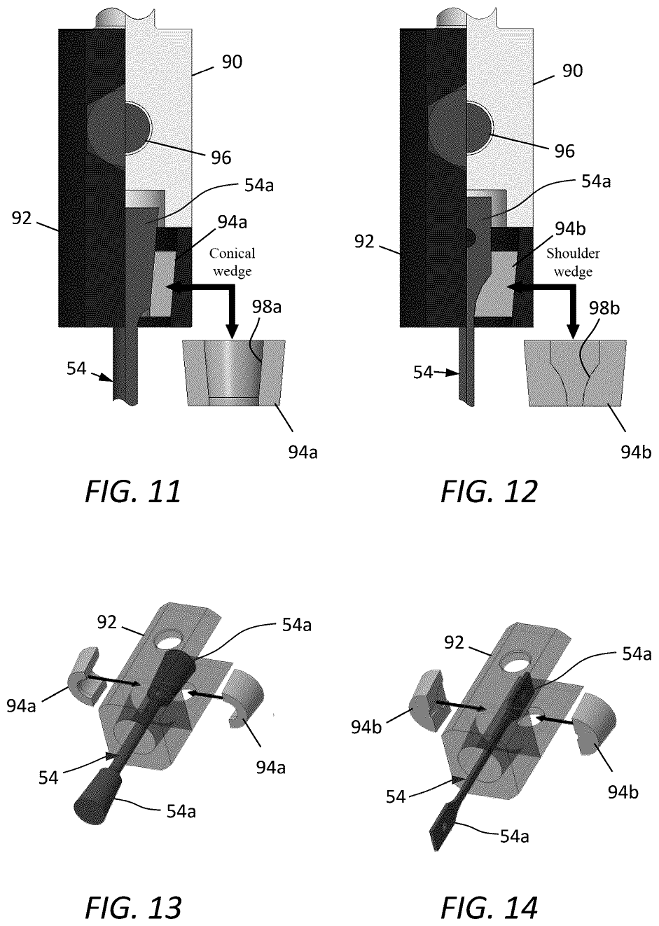

The grip assemblies 52 and 56 of the specimen mount assembly 26 are believed to overcome other challenges in traditional gripping mechanisms by combining a shoulder design with a wedge, as exemplified in FIGS. 10 through 14. Traditional gripping mechanisms, such as threading for cylindrical specimens and pin-holes for flat plate specimens, have posed a significant challenge regarding unwanted local stresses in certain test specimens that could exceed stresses in the gauge length of the specimen. Consequently, creep would be measured both in the gauge length and in the grip contact region of the specimen, thereby providing less than optimal test data. The grip assemblies 52 and 56 in the in-situ creep capsule 20 overcome this issue of unwanted stresses by using wedges 94 to secure the ends of the specimen 54. The wedges 94 clamp a head portion 54a of the test specimen 54 when pulled in a direction toward a tapered end of the wedge 94 while also allowing for the possibility of some movement in the opposite direction away from the tapered end. Thus, the wedges 94 do not necessarily rigidly clamp the specimen 54.

As best seen in FIGS. 10-16 (as well as FIGS. 2 and 7), each grip assembly 52 and 56 includes an aforementioned grip mount 90, a cap 92, wedges 94, and a pin (e.g., a bolt) 96. Each of the upper grip assembly 52 and lower grip assembly 56 have substantially the same components with minor differences in some dimensions. Therefore, unless otherwise detailed herein, only descriptions of the components and functioning of the upper grip assembly 52 is provided here with the understanding that the description and functioning of the components of the lower grip assembly 56 are substantially the same.

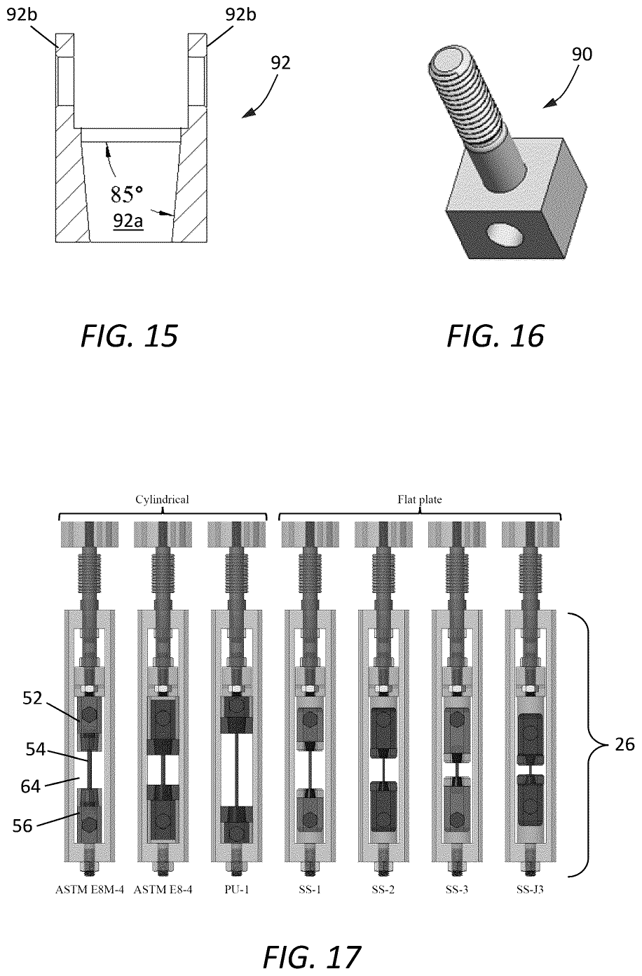

As best seen in FIGS. 7 and 10, in the upper grip assembly 52, the pin portion of the grip mount 90 extends upwardly through a vertical threaded bore through the center of the brace mount 50 and secured with a nut or other fastener such that the main body of the grip mount 90 is clamped tightly against the lower surface of the brace mount 50. The cap 92 (shown in isolation in FIG. 15) is secured to the main body of the grip mount 90 such that a cavity 92a for receiving the wedges 94 and head (end) portion 54a of the test specimen 54 is located directly below the main body of the grip mount 90. In this example, the cap 92 includes a pair of spaced apart flange walls 92b extending upwardly from the cavity 92a. The flange walls 92b fit against opposite sides of the main body of the grip mount 90. The cap 92 is secured to the main body of the grip mount 90 by a pin 96 that extends laterally through aligned through-holes in the opposite flange walls 92b of the cap 92 and the main body of the grip mount 90. The interior surface of the cavity 92a in the cap 92 has a substantially frustoconical profile that is wider at the end near the flange walls 92b and narrower at the opposite end. In this embodiment, the interior surface of the cavity 92a defining the frustoconical profile has an angle of approximately 15° from the longitudinal axis of the specimen 54 (approximately 85° from the lateral plane as shown in FIG. 15).

FIGS. 10, 11, and 13 show a first configuration of the grip assemblies 52 and 56 that uses wedges 94 that have a frustoconical interior surface profile 98a (also referred to as “conical wedges 94a”) shaped for gripping the cylindrical specimen. FIGS. 12 and 14 show a second configuration of the grip assemblies 52 and 56 that incorporates wedges 94 that have a shoulder interior surface profile 98b (also referred to as “shoulder wedges 94b”) shaped for gripping the flat plate specimens 54. Each grip assembly 52 and 56 can be tailored for a unique shape of each specimen 54, and particularly the head portions 54a of the specimen 54. In the conical wedges 94a used for the cylindrical specimens, the threading typically used for cylindrical specimens in conventional ICCs has been substituted with the frustoconical interior surface profile 98a of the conical wedges 94a, which removes unwanted local stresses that are associated with threading. In some embodiments, the interior surface profile 98a may be tapered to have angle of about 5° relative to the axis of the cap 92. With respect to the shoulder wedges 94b for the flat plate specimen 54, the shoulders 98b are used to grip the specimen 54 instead of a pin, which creates more a uniform stress profile in the gauge length of a flat plate specimen 54. The shoulders 98b have the same complementary silhouette as the head portion 54a of the test specimen 54 machined from the center. The shoulders 98b keep the specimen 54 from freely moving in the vertical direction ensure that the highest stresses are located in the gauge length of the specimen 54. A uniform stress throughout the gauge length of a specimen 54 is established by the wedges 94 restricting the movement of the specimen 54 in the normal direction of the face of the flat plate specimen 54. The wedge design helps to secure the specimen 54 within the cap 92 and respective grip assembly 52 or 56 while removing or at least reducing the possibility of unwanted bending moments in the specimen 54. The exterior surfaces of each type of wedge 94 (the conical wedges 94a and the shoulder wedges 94b) have a generally frustoconical surface that conforms to the generally frustoconical interior surface of the cavity 92a within the cap 92. In some embodiments, the angle of the exterior frustoconical surface of the wedges 94 may be approximately 5°. In other embodiments, the angle of the exterior frustoconical surface of the wedges 94 may be approximately 15° or some other angle to match the angle of the interior surface within the cavity 92a of the cap 92.

As best seen in FIGS. 13 and 14, in each grip assembly 52 and 56 the respective upper or lower head portion 54a of the test specimen 54 is secured with two appropriately selected wedges 94, wherein each wedge 94 forms about half a circumference (i.e., about 180° angular sweep) around the head portion 54a of the test specimen 54. In other embodiments, the wedges 94 may have smaller circumferential extents and three or more such smaller wedges 94 could be inserted around the radial periphery of the head portion 54a of the test specimen 54. The symmetry of the grip assemblies 52 and 56 in the vertical planes depicted in FIGS. 13 and 14 is believed to assist with reducing bending moments in the specimen 54.

To anchor the head portion 54a of the test specimen 54 in either grip assembly 52 and 56, the head portion 54a of the test specimen 54 is inserted into the cavity 92a of the cap 92, and the appropriate wedges 94 are placed in the cavity 92a between the head portion 54a of the test specimen 54 and the frustoconical interior surface of the cavity 92a, as shown in FIGS. 10-12. Since the cap 92 has a larger diameter due to the wedges 94, the head portion 54a of the specimen 54 can pass through the cavity 92a in the cap 92 for simple assembly. In this position, the wedges 94 are wedged between the interior wall of the cap 92 and the exterior surface of the head portion 54a of the test specimen 54, which prevents the head portion 54a from pulling out of the cavity 92a in the cap 92 in the direction toward the wedges 94. The main body of the grip mount 90 is then secured to the cap 92 with the pin 96. In the upper grip assembly 52, the grip mount 90 is secured to the brace mount 50 as described previously. In the lower grip assembly 56, the pin 96 of the grip mount 90 is inserted through the slot 86 at the lower end of the yoke 58 and may be secured with a nut or other fastener. Thus, the grip mounts 90 thereby secure the entire assembled grip assemblies 52 and 56 with the test specimen 54 secured therebetween to the respective brace mount 50 and lower end of the yoke 58 and prevent the head portion 54a of the specimen 54 from sliding out of the cavity 92a of the cap 92 in the direction away from the wedges 94.

As noted above, the wedge design, which can be used for both the cylindrical and flat plate specimens 54, helps mitigate potential bending moments. In addition, the grip assemblies 52 and 56 allow the specimen 54 or the wedges 94 to expand without creating unwanted thermal stresses or dimensional deviations between the grip assemblies 52 and 56, thereby reducing any buckling or torsional forces that could distort the test data. Furthermore, the entire assembly of the upper and lower grip assemblies 52 and 56 and the specimen 54 secured therebetween can be readily sized to fit within a test volume 64, e.g., a length and width of 80 mm and 16 mm, respectively.

In some configurations, a gap 100 of about 5 mm is present between the upper grip mount 90 and the transducer probe 46 to allow the bellows 44 to expand without hindrance. For example, a metallic bellows 44 typically has a working range of about 3 mm. In addition, the gap 100 provides a safety function. If the bellows 44 were to burst, then the brace mount 50 would hold the lower part of the capsule 20 (specimen mount assembly 26) in a safe position.

The specimen mount assembly 26 is an open design that fully exposes the specimen 54 to the coolant of a reactor when operatively installed in a nuclear reactor core for a test procedure. Because of the open design, the capsule 20 can be placed into a loop system, a basket, or straight into a reactor core and still expose the specimen 54 to the test medium, which adds to the versatility of the capsule 20.

Previous ICCs have often experienced friction due to buckling and thermal expansion in both the probe and load-transferring links, which have undesirably affected the testing capabilities of previous ICC. The in-situ creep capsule 20 of the present invention, however, overcomes the buckling and friction issues of conventional ICCs by reducing the distance between the instruments and test specimen. The capsule 20 also reduces the buckling and friction issues of conventional ICCs by locating the loading mechanism (in this example, the bellows 44) and strain measuring instrument (in this example the LVDT 60) near the specimen 54. In addition, locating the loading mechanism and strain measuring instrument near the specimen allows the capsule 20 to collect accurate creep data during an irradiation experiment without having to remove the capsule 20 from the reactor and rather than having to collect the data after the experiment outside of the reactor.

In preferred configurations, the capsule 20 can meet one or more of three parameters or factors. The first factor is the test volume available within the nuclear reactor. For example, the capsule 20 in some nonlimiting configurations can fit within a loop system or basket that separates the reactor coolant from the capsule 20. Due to the limited space within a reactor core, the capsule 20 preferably has a slim profile with a diameter ranging between about 23.5 to 60 mm. The second factor is the exposure to harsh environmental conditions, especially in next-generation reactors. For example, in some nonlimiting configurations the capsule 20 can operate while exposed to temperatures of up to at least 1000° C. and perform in corrosive coolants, such as lead, lead-bismuth, molten salt, and sodium, as these are environmental conditions in next-generation reactors. The third factor is versatility. For example, the capsule 20 can be configured to perform experiments on various specimen geometries. In order to improve its functionality, the capsule 20 has a modular design that can be used to test various specimen geometries. The ability to test various types of specimens with a single modular design for the capsule 20 provides the opportunity to test many candidate materials with different creep rates. In one preferred embodiment, the capsule 20 has a diameter between about 90 mm to about 25 mm, more preferably between about 60 mm and about 30 mm, and most preferably about 32 mm, the height (axial length) is between about 500 mm and about 300 mm, more preferably between about 475 mm and about 310 mm, and most preferably about 316 mm. A capsule 20 having an axial length (height) of about 315.84 mm and a diameter of about 31.75 is preferred because it allows the capsule 20 to fit within a reasonably large number of different loop systems and reactor test volumes having variety of different sizes. However, the invention is not necessarily limited to an ICC that meets any or all of these particular parameters.

Modeling tests showed that the design of the capsule 20 is well suited for operation at temperatures of at least 600° C. and tensile stresses of at least 200 MPa. A finite element analysis (FEA) of the capsule 20 was performed to ensure that the capsule 20 is structurally stable and the stresses are properly distributed. If stresses in the structural parts are higher than those in the specimen, creep will occur at unwanted locations, which will distort the creep data. For all analyses, loads were applied to create 200 MPa in the gauge length of a specimen with a frustoconical grip design as described above. The FEA solution of the capsule 20 showed that the highest stresses are optimally located at the gauge length of the specimen, with other stresses throughout the assembly dramatically lower than the stress in the gauge length. The FEA test results provided a reliable indication that the design of the capsule 20 is capable of operating at least at 600° C., with a 200 MPa tensile stress in the gauge length, and possibly at higher operating temperatures and tensile stress.

As previously noted above, though the foregoing detailed description describes certain aspects of one or more particular embodiments of the invention, alternatives could be adopted by one skilled in the art. For example, the in-situ creep capsule 20 and/or its various components could differ in appearance and construction from the embodiments described herein and shown in the drawings, functions of certain components of the in-situ creep capsule 20 could be performed by components of different construction but capable of a similar (though not necessarily equivalent) function, and various materials could be used in the fabrication of the in-situ creep capsule 20 and/or its components. As such, and again as was previously noted, it should be understood that the invention is not necessarily limited to any particular embodiment described herein or illustrated in the drawings.

1. An in-situ creep capsule for a nuclear reactor, the in-situ creep capsule comprising:
a specimen mount assembly for securing a test specimen between a first grip assembly and a second grip assembly within a test volume;
a loading assembly comprising a loading mechanism for placing a load on the test specimen secured between the first and second grip assemblies; and
a transducer assembly comprising instruments for measuring strain in the test specimen secured between the first and second grip assemblies when subjected a load from the loading assembly;
wherein at least one of the first and second grip assemblies comprises a wedge and a cap, wherein the wedge wedges a head portion of a testing specimen within the cap to secure the testing specimen.

2. The in-situ creep capsule of claim 1, wherein the first and second grip assemblies have a first configuration to secure a first test specimen having a first shape and a second configuration to secure a second test specimen having a second shape.

3. The in-situ creep capsule of claim 2, wherein in the first configuration, the wedge comprises a frustoconical wedge.

4. The in-situ creep capsule of claim 2, wherein in the second configuration, the wedge comprises a shoulder wedge.

5. The in-situ creep capsule of claim 1, wherein the loading mechanism comprises a bellows.

6. The in-situ creep capsule of claim 1, wherein the instruments for measuring strain comprise a linear variable differential transducer.

7. An in-situ creep capsule for a nuclear reactor, the in-situ creep capsule comprising:
a specimen mount assembly for securing a test specimen within a test volume;
a loading assembly comprising a loading mechanism for placing a load on the test specimen secured between the first and second grip assemblies; and
a transducer assembly comprising an instrument for measuring strain in the test specimen secured in the specimen mount assembly when subjected a load from the loading assembly;
wherein the transducer assembly comprises an integrated heat exchanger for cooling the instrument.

8. The in-situ creep capsule of claim 7, wherein the instrument for measuring strain comprises a linear variable differential transducer (LVDT) carried by a transducer mount, and wherein the integrated heat exchanger comprises:
a transducer shell enclosing the LVDT and coupled to the transducer mount; and
a coolant flow circuit defined through the transducer shell that passes across at least a portion of the LVDT.

9. The in-situ creep capsule of claim of claim 8, wherein the transducer shell comprises a coolant inlet and a coolant outlet, and wherein the LVDT is disposed between the coolant inlet and the coolant outlet.

10. The in-situ creep capsule of claim 9, wherein the LVDT is disposed entirely between the coolant inlet and the coolant outlet.

11. The in-situ creep capsule of claim 8, wherein the transducer mount comprises a hollow rod section extending upwardly from a base section, wherein coils of the LVDT are mounted on an exterior of the hollow rod section, wherein the transducer shell surrounds the hollow rod section, and wherein a distal end of the hollow rod section has a chamfered peripheral edge to direct flow of coolant around the coils.

12. The in-situ creep capsule of claim 11, wherein a transducer core of the LVDT is disposed inside the hollow rod section opposite the coils.

13. The in-situ creep capsule of claim 9, further comprising a transducer lead tube coupled to a coolant inlet, wherein the coolant flow circuit and a lead from the LVDT extend through the coolant inlet and the transducer lead tube.

14. An in-situ creep capsule for a nuclear reactor, the in-situ creep capsule comprising:
a specimen mount assembly comprising one or more grip assemblies for securing a test specimen within a test volume;
a loading assembly comprising a loading mechanism for placing a load on the test specimen secured between the first and second grip assemblies; and
a transducer assembly comprising instruments for measuring strain in the test specimen secured in the specimen mount assembly when subjected a load from the loading assembly;
wherein the loading assembly comprises a brace rod;
wherein the specimen mount assembly comprises a brace mount; and
wherein the brace rod slides into the brace mount to couple the specimen mount assembly to the loading assembly.

15. The in-situ creep capsule of claim 14, wherein the loading assembly comprises two brace rods in a first direction from a transducer mount of the transducer assembly and spaced apart from each other a fixed distance, and
wherein a first end of each brace rod is coupled to the transducer mount, and a second end of each brace rod is coupled to the brace mount.

16. The in-situ creep capsule of claim 15, wherein the brace mount comprises a first slot and a second slot disposed on opposite sides of the brace mount, and wherein each of the two brace rods slides into and is secured in a respective one of the first and second slots.

17. The in-situ creep capsule of claim 14, wherein the specimen mount assembly, the loading assembly, and the transducer assembly have a modular configuration, wherein any one or more of the specimen mount assembly, the loading assembly, and the transducer assembly can be configured separately from the other ones of the specimen mount assembly, the loading assembly, and the transducer assembly.

18. A method of measuring creep in a test specimen in a nuclear reactor, the method comprising:
loading the test specimen in an in-situ creep capsule of claim 1 and securing the head portion of the test specimen in the cap with the wedge; and
placing the in-situ creep capsule loaded with the test specimen in a reactor core of a nuclear reactor while the nuclear reactor is running for a period of time; and
measuring creep of the test specimen during the time period using the in-situ creep capsule.

19. The method of claim 18, wherein the step of loading comprises:
selecting a wedge from a plurality of wedges having different shapes to accommodate test specimens of respective different shapes, wherein the selected wedge corresponds to the shape of the test specimen; and
securing the test specimen in a grip assembly using the selected wedge.

20. The method of claim 19, wherein the plurality of wedges comprise a frustoconical wedge and shoulder wedge, wherein the frustoconical wedge is configured to secure a cylindrical test specimen and the shoulder wedge is configured to secure a flat plate specimen.

21. A method of measuring creep in a test specimen in a nuclear reactor, the method comprising:
loading the test specimen in an in-situ creep capsule of claim 7;
placing the in-situ creep capsule loaded with the test specimen in a reactor core of a nuclear reactor while the nuclear reactor is running for a period of time;
measuring creep of the test specimen during the time period using the in-situ creep capsule; and
cooling the instrument for measuring strain using the integrated heat exchanger.

22. The method of claim 21, wherein the step of cooling comprises forming a flow of coolant through a transducer shell enclosing the instrument along a coolant flow circuit that passes across at least a portion of the instrument.

23. The method of claim 22, wherein the instrument comprises a linear variable differential transducer including transducer coils, wherein the coolant flows across the transducer coils.
